(19) United States
(12) Patent Application Publication
(10) Pub. No.: US 2023/0290124 A1
(43) Pub. Date: Sep. 14, 2023

(54) COMPUTER-READABLE RECORDING MEDIUM STORING IMAGE PROCESSING PROGRAM, IMAGE PROCESSING METHOD, AND INFORMATION PROCESSING APPARATUS

(71) Applicant: Fujitsu Limited, Kawasaki-shi (JP)

(72) Inventors: Kenji KOBAYASHI, Kawasaki (JP); Tsukasa MAKINO, Yokohama (JP); Tomonori MASE, Nagano (JP); HARUYUKI ISHIDA, Kawasaki (JP)

(73) Assignee: Fujitsu Limited, Kawasaki-shi (JP)

(21) Appl. No.: 18/150,380

(22) Filed: Jan. 5, 2023

(30) Foreign Application Priority Data
Mar. 9, 2022 (JP) 2022-036502

(51) Int. Cl. G06V 10/774; G06V 10/764; G06V 10/74; G06V 20/58

(52) U.S. Cl. CPC G06V 10/774; G06V 10/764; G06V 10/761; G06V 20/58

(57) ABSTRACT

A non-transitory computer-readable recording medium stores an image processing program for causing a computer to execute a process including: obtaining a plurality of images consecutively captured in a time series manner; calculating a probability that a type of an object present in each of the plurality of images is one type using a trained classification model; determining whether or not the probability that the type of the object is the one type periodically changes in consecutive images among the plurality of images; and in a case of determining that the probability periodically changes, saving one image within a period in which the probability that the type of the object is the one type periodically changes as training data.

### CROSS-REFERENCE TO RELATED APPLICATION

This application is based upon and claims the benefit of priority of the prior Japanese Patent Application No. 2022-36502, filed on Mar. 9, 2022, the entire contents of which are incorporated herein by reference.

### FIELD

The embodiments discussed herein are related to an image processing program, an image processing method, and an information processing apparatus.

### BACKGROUND

Class classification is one of machine learning using computers. The class classification is used to, for example, predict a type of an object present in a captured image. The class classification may be carried out with high accuracy by using deep learning such as multilayer neural networks.

Japanese Laid-open Patent Publication No. 2013-250881 is disclosed as related art.

### SUMMARY

According to an aspect of the embodiments, a non-transitory computer-readable recording medium stores an image processing program for causing a computer to execute a process including: obtaining a plurality of images consecutively captured in a time series manner; calculating a probability that a type of an object present in each of the plurality of images is one type using a trained classification model; determining whether or not the probability that the type of the object is the one type periodically changes in consecutive images among the plurality of images; and in a case of determining that the probability periodically changes, saving one image within a period in which the probability that the type of the object is the one type periodically changes as training data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary process using an image processing method according to a first embodiment;

FIG. 2 is a diagram illustrating an exemplary system configuration according to a second embodiment;

FIG. 3 is a diagram illustrating exemplary hardware of an edge device;

FIG. 4 is a block diagram illustrating functions of the edge device;

FIG. 5 is a diagram illustrating exemplary object image extraction from a captured image;

FIG. 6 is a diagram illustrating an exemplary process of determining a type of an object;

FIG. 7 is a diagram illustrating exemplary temporary saving of an object image;

FIG. 8 is a diagram illustrating exemplary similarity level comparison of object images;

FIG. 9 is a diagram illustrating an exemplary periodicity management table;

FIG. 10 is a flowchart illustrating an exemplary procedure of a training data generation process;

FIG. 11 is a first half of a flowchart illustrating an exemplary procedure of an image selection process; and

FIG. 12 is a latter half of the flowchart illustrating the exemplary procedure of the image selection process.

### DESCRIPTION OF EMBODIMENTS

A trained model used for the class classification may be retrained after generation to improve classification accuracy. In the case of retraining the model, training data is created by selecting images that largely contribute to the classification accuracy from a large number of images. It commonly takes a lot of time to select images. As a method for the image selection, for example, a method of manually selecting images, a method of omitting excessive images from an average value and a variance value of the images, and the like have been known. Furthermore, there has been proposed a method for training image selection in which a similarity level between each feature value of a training image candidate and a feature value of the entire training image is calculated and the training image candidate with the similarity level higher than a threshold value is selected as training image data.

According to existing image selection, a large number of images, such as candidate images for training data that may not be used or training data that has already been used for training, are collected and retained. When images not ultimately used as the training data are collected from other devices and saved, a large volume of storage capacity is consumed and a communication load increases, resulting in an inefficient training data generation process. Then, at the time of image selection, the large amount of saved images are subject to a comparison process and the like, and the overall data processing volume increases. In view of the above, there has been a demand for efficient acquisition of images useful as training data.

In one aspect, the present case aims to efficiently obtain images useful as training data.

Hereinafter, the present embodiments will be described with reference to the drawings. Note that each of the embodiments may be implemented in combination with a plurality of embodiments as long as no contradiction arises.

### First Embodiment

A first embodiment is directed to an image processing method for efficiently obtaining images useful as training data.

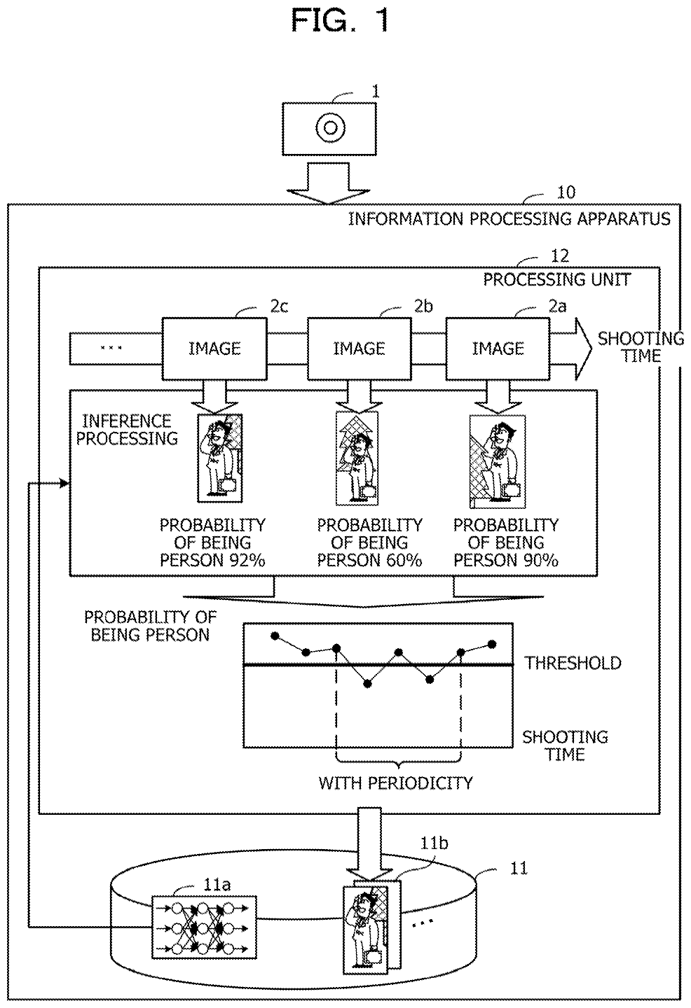

FIG. 1 is a diagram illustrating an exemplary process using the image processing method according to the first embodiment. In the example of FIG. 1, the image processing method is carried out using an information processing apparatus 10. The information processing apparatus 10 implements the image processing method by, for example, executing an image processing program.

The information processing apparatus 10 includes a storage unit 11 and a processing unit 12. The storage unit 11 is, for example, a memory or a storage device included in the information processing apparatus 10. The processing unit 12 is, for example, a processor or another arithmetic circuit included in the information processing apparatus 10.

The storage unit 11 stores a classification model 11a and training data 11b. The classification model 11a is a model that has already been trained by machine learning, and is used to determine a type of an object present in an image. In the type determination (inference processing) using the classification model 11a, a probability of being each type out of a plurality of types is obtained. A type with the highest probability is determined to be the type of the object present in the image. The training data 11b is one or more images to be used to retrain the classification model 11a.

A camera 1 is connected to the information processing apparatus 10. The processing unit 12 of the information processing apparatus 10 obtains a plurality of images 2a, 2b, 2c, and so on consecutively (e.g., at regular intervals) captured by the camera 1 in a time series manner. The processing unit 12 calculates a probability that the type of the object present in each of the plurality of images 2a, 2b, 2c, and so on is one type using the trained classification model 11a. In the example of FIG. 1, a probability that the type of the object is a person is calculated. Note that, when the classification model 11a is used, a probability that the object is of the type may be calculated for each of the plurality of types. In that case, the processing unit 12 carries out subsequent processing with the type with the highest probability as one type to be processed. Hereinafter, the probability that the type of the object is one type will be referred to as a confidence level.

After calculating the confidence level, the processing unit 12 determines whether or not the confidence level periodically changes in consecutive images among the plurality of images 2a, 2b, 2c, and so on. For example, the processing unit 12 determines whether or not an image with the confidence level exceeding a predetermined threshold value and an image with the confidence level not exceeding the threshold value are alternately repeated equal to or more than a predetermined number of times. Then, the processing unit 12 determines that there is a periodic change when the image with the confidence level exceeding the predetermined threshold value and the image with the confidence level not exceeding the threshold value are alternately repeated equal to or more than the predetermined number of times.

The predetermined threshold value is, for example, a value corresponding to determination accuracy of one type by the classification model 11a. The determination accuracy of the classification model 11a is represented by a probability (accuracy rate) of correctly classifying an object present in an image by inputting an image to which a ground truth label is assigned to the classification model 11a. The information processing apparatus 10 uses, for example, the accuracy rate for one type by the classification model 11a as a predetermined threshold value for determining periodicity. When the determination accuracy of the classification model 11a improves by retraining of the classification model 11a using the training data 11b, the information processing apparatus 10 may update the predetermined threshold value according to the improved determination accuracy. This makes it possible to extract an appropriate image as the training data 11b according to the determination accuracy of the classification model 11a.

When the processing unit 12 determines that there is a periodic change, it saves one image within the period in which the confidence level periodically changes as the training data 11b. For example, the processing unit 12 may set a partial image obtained by cutting out a region where an object of one type is present in an image within the period in which the confidence level periodically changes as one image to be saved as the training data 11b.

In this manner, when there is periodicity in the confidence level change during a certain period, images within the period is set as the training data 11b, whereby it becomes possible to efficiently obtain images useful as the training data 11b.

For example, a case where the confidence level of being one type (e.g., person) periodically changes indicates a case where a result of determination of being the type tends to largely fluctuate with a slight image difference. In such a case, the determination result may be erroneous. In view of the above, a user sets an image within the period in which the confidence level periodically changes as the training data 11b, confirms the image of the training data 11b, and assigns a ground truth label. Then, the user causes the information processing apparatus 10 or another computer to retrain the classification model 11a using the training data 11b with the ground truth label. As a result, parameters of the classification model 11a are corrected so that an image with a high possibility of an erroneous determination result may be correctly determined. For example, weight parameters are corrected by the retraining when the classification model 11a is a neural network.

With the retraining using images within the period in which the change in the confidence level has periodicity as training data in this manner, it becomes possible to improve the classification accuracy of the classification model 11a. For example, the images within the period in which the change in the confidence level has periodicity are images that contribute to the improvement of the accuracy of the classification model 11a.

Additionally, by simply determining the periodicity of the confidence level obtained at the time of classifying the object present in the image using the classification model 11a, it becomes possible to extract images that contribute to the improvement of the accuracy of the classification model 11a without saving a large number of images and comparing images among the large number of images. Accordingly, it becomes possible to efficiently obtain the images that contribute to the improvement of the accuracy of the classification model 11a.

Furthermore, by determining whether or not there is periodicity on the basis of a predetermined threshold value, it becomes possible to suppress erroneous inclusion of images that do not contribute to the improvement of the accuracy of the classification model 11a in the training data 11b as images that contribute to the improvement of the accuracy of the classification model 11a. For example, even in a case where there is periodicity in the range of equal to or more than 90% with respect to the confidence level that an object present in an image within a certain period is a person, it is still determined to be a person with a high confidence level. In that case, the image may already be correctly determined to be a person, and retraining of the classification model 11a using the object image does not contribute to the improvement of the accuracy of the classification model 11a. Similarly, even in a case where there is periodicity in the range of equal to or less than 10% with respect to the confidence level that an object present in an image within a certain period is a person, it is already possible to correctly determine that the image is not a person, which does not contribute to the improvement of the accuracy of the classification model 11a.

By determining whether or not there is periodicity on the basis of the threshold value, even in a case where the confidence level has periodicity in a range that does not cross the threshold value, it is not determined to have periodicity. For example, when the threshold value is set to approximately 60%, periodicity with the confidence level of approximately 90% or periodicity with the confidence level of approximately 10% is ignored. As a result, inclusion of images that do not contribute to the improvement of the accuracy of the classification model 11a in the training data 11b is suppressed.

Furthermore, the processing unit 12 may calculate the similarity level between an image within the period in which the confidence level has periodicity and each of images saved as the training data 11b, and may save the image within the period in which the confidence level has periodicity as the training data 11b when the similarity level satisfies a predetermined condition. For example, the predetermined condition of the similarity level is that the similarity level between an image within the period in which the confidence level has periodicity and at least one of the images saved as the training data is lower than a predetermined similarity threshold value. This makes it possible to suppress addition of images similar to the images already included in the training data 11b to the training data 11b. As a result, it becomes possible to suppress the data volume of the training data 11b, and to efficiently retrain the classification model 11a using the training data 11b.

Note that the processing unit 12 may decrease the value of the predetermined number of times when it is not determined that there is a periodic change for a predetermined period of time. With the predetermined number of times decreased, the condition for determining that there is a periodic change is relaxed. By gradually lowering the value of the predetermined number of times indicating the upper limit of the number of repetitions in this manner, it becomes possible to automatically adjust the predetermined number of times to an appropriate value.

### Second Embodiment

Next, a second embodiment will be described. The second embodiment is designed to efficiently collect images that contribute to accuracy in determining obstacles and the like in images captured by a vehicle-mounted camera.

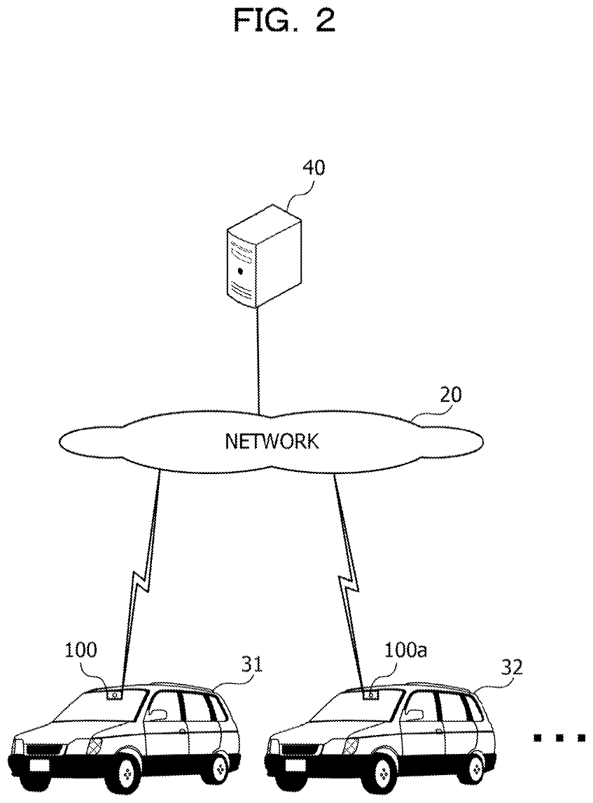

FIG. 2 is a diagram illustrating an exemplary system configuration according to the second embodiment. For example, edge devices 100, 100a, and so on are installed in a plurality of vehicles 31, 32, and so on, respectively. The edge devices 100, 100a, and so on are connected to a network 20 using wireless communication, and are capable of communicating with a server 40 via the network 20. The edge devices 100, 100a, and so on select images that contribute to improvement of accuracy in determining a classification model that determines a type of an object present in the images from among images captured by a camera, for example, and transmit the images to the server 40. The server 40 retrains the classification model using the images collected from the edge devices 100, 100a, and so on as training data.

For example, the classification model may be used in a vehicle collision detection system. The collision detection system automatically operates brakes or a steering wheel according to the type of the object determined by the classification model and movement of the object. At a development stage of the collision detection system, the vehicles 31, 32, and so on equipped with the edge devices 100, 100a, and so on are driven to collect training data, thereby improving the accuracy of the classification model.

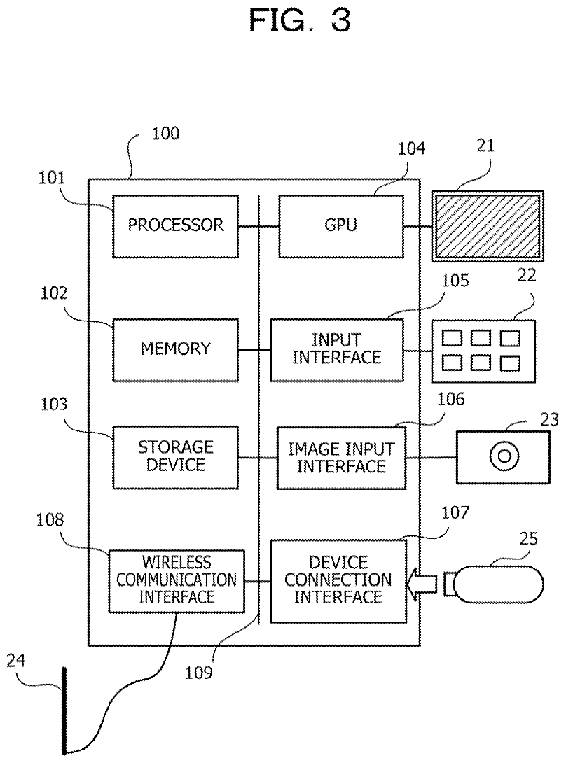

FIG. 3 is a diagram illustrating exemplary hardware of the edge device. The edge device 100 is subject to overall control performed by a processor 101. A memory 102 and a plurality of peripheral devices are connected to the processor 101 via a bus 109. The processor 101 may be a multiprocessor. The processor 101 is, for example, a central processing unit (CPU), a micro processing unit (MPU), or a digital signal processor (DSP). At least a part of functions implemented by the processor 101 executing a program may be implemented by an electronic circuit such as an application specific integrated circuit (ASIC) or a programmable logic device (PLD).

The memory 102 is used as a main memory of the edge device 100. The memory 102 temporarily stores at least a part of an operating system (OS) program and an application program to be executed by the processor 101. Furthermore, the memory 102 stores various types of data to be used in processing by the processor 101. As the memory 102, for example, a volatile semiconductor storage device such as a random access memory (RAM) is used.

Examples of the peripheral devices connected to the bus 109 include a storage device 103, a graphics processing unit (GPU) 104, an input interface 105, an image input interface 106, a device connection interface 107, and a wireless communication interface 108.

The storage device 103 electrically or magnetically performs data writing and reading on a built-in recording medium. The storage device 103 is used as an auxiliary storage device of a computer. The storage device 103 stores an OS program, an application program, and various types of data. Note that, as the storage device 103, for example, a hard disk drive (HDD) or a solid state drive (SSD) may be used.

The GPU 104 is an arithmetic unit that performs image processing, and is also called a graphic controller. A monitor 21 is connected to the GPU 104. The GPU 104 causes an image to be displayed on a screen of the monitor 21 in accordance with an instruction from the processor 101. Examples of the monitor 21 include a display device using organic electro luminescence (EL), a liquid crystal display device, and the like.

An input device 22 is connected to the input interface 105. The input device 22 has, for example, a plurality of input keys to which predetermined functions are assigned. Furthermore, a pointing device such as a touch panel may also be used as the input device 22. The input interface 105 transmits signals transmitted from the input device 22 to the processor 101.

A camera 23 is connected to the image input interface 106. The camera 23 is installed in such a manner that a forward image may be captured from inside of the vehicle 31, for example. The image input interface 106 receives images transmitted from the camera 23, and saves them in the storage device 103.

The device connection interface 107 is a communication interface for connecting the peripheral devices to the edge device 100. For example, a memory device 25 may be connected to the device connection interface 107. The memory device 25 is a recording medium equipped with a communication function with the device connection interface 107.

An antenna 24 is connected to the wireless communication interface 108. The wireless communication interface 108 communicates with a base station connected to the network 20 via the antenna 24. Then, the wireless communication interface 108 transmits/receives data to/from the server 40 via the network 20.

The edge device 100 may implement a processing function of the second embodiment with the hardware as described above. Note that the information processing apparatus 10 described in the first embodiment may also be implemented by hardware similar to that of the edge device 100 illustrated in FIG. 3.

The edge device 100 implements the processing function of the second embodiment by executing, for example, a program recorded in a computer-readable recording medium. The program in which processing content to be executed by the edge device 100 is described may be recorded in various recording media. For example, the program to be executed by the edge device 100 may be stored in the storage device 103. The processor 101 loads at least a part of the program in the storage device 103 into the memory 102, and executes the program. Furthermore, it is also possible to record the program to be executed by the edge device 100 in the memory device 25 or in a portable recording medium such as an optical disk or a memory card. The program stored in the portable recording medium may be executed after being installed in the storage device 103 under the control of the processor 101, for example. Furthermore, the processor 101 may read the program directly from the portable recording medium to execute it.

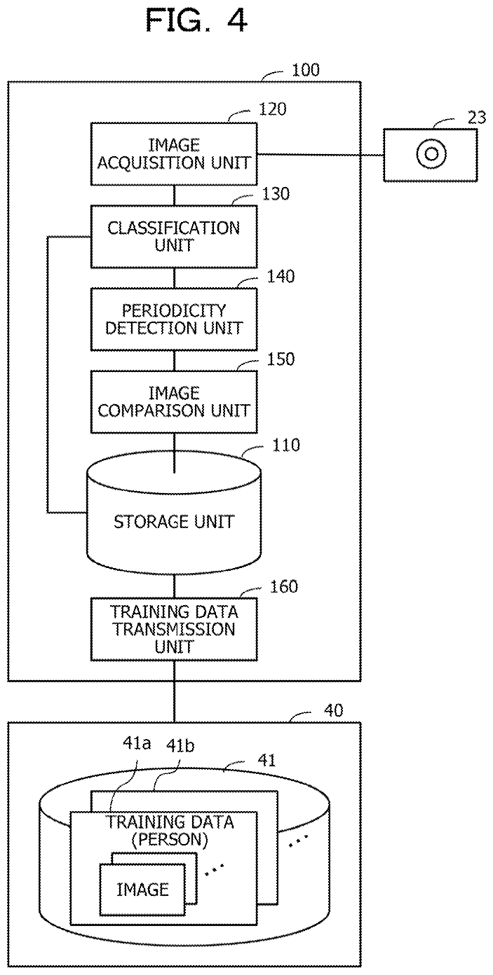

FIG. 4 is a block diagram illustrating functions of the edge device. The edge device 100 includes a storage unit 110, an image acquisition unit 120, a classification unit 130, a periodicity detection unit 140, an image comparison unit 150, and a training data transmission unit 160.

The storage unit 110 stores images to be used as training data and the classification model to be used to determine a type of an object present in the images. The classification model is, for example, a multilayer neural network. The storage unit 110 is implemented by, for example, using a part of a storage area of the storage device 103 included in the edge device 100.

The image acquisition unit 120 obtains images captured by the camera 23 at predetermined intervals. The image acquisition unit 120 transmits the obtained images to the classification unit 130.

Upon reception of the images from the image acquisition unit 120, the classification unit 130 determines a type of an object present in the images using the classification model stored in the storage unit 110. For example, when a human-shaped object is present in the images, the classification unit 130 calculates a probability that the object is a person. The classification unit 130 transmits a classification result to the periodicity detection unit 140. The classification result includes, for example, an image of the object, a name of a type of the object with the highest probability (person, vehicle, etc.) and possibility (confidence level) of being the type.

The periodicity detection unit 140 detects periodicity of the confidence level on the basis of the classification result. For example, the periodicity detection unit 140 determines that there is periodicity when the confidence level repeatedly rises and falls across a predetermined threshold value. When the periodicity detection unit 140 determines that there is periodicity, it transmits the classification result to the image comparison unit 150. Furthermore, when the periodicity detection unit 140 determines that there is no periodicity, it discards the classification result.

The image comparison unit 150 compares the image of the classification result determined to have periodicity with the images stored in the storage unit 110 as the training data. Then, when the image of the classification result determined to have periodicity is similar to all (or equal to or more than a predetermined ratio) of the images of the training data, the image comparison unit 150 discards the obtained classification result. When the image of the classification result determined to have periodicity is dissimilar to a part (or less than a predetermined ratio) of the images of the training data, the image comparison unit 150 stores the image included in the obtained classification result in the storage unit 110 as training data corresponding to the type of the image.

When equal to or more than a predetermined amount of training data is stored in the storage unit 110, the training data transmission unit 160 transmits the training data to the server 40. Then, the training data transmission unit 160 deletes the training data transmitted to the server 40 from the storage unit 110.

The server 40 includes a storage unit 41. The storage unit 41 stores training data 41a, 41b, and so on for individual image types. Each of the training data 41a, 41b, and so on includes multiple images classified into the corresponding type. Upon reception of the image of the training data from the edge device 100, the server 40 stores the received image in the storage unit 41 as training data corresponding to the type of the image.

Note that, lines connecting the individual elements illustrated in FIG. 4 indicate a part of a communication path, and a communication path other than the illustrated communication path may also be set. Furthermore, the function of each element illustrated in FIG. 4 may be implemented by, for example, causing a computer to execute a program corresponding to the element.

The edge device 100 having the functions as illustrated in FIG. 4 selects images that contribute to the improvement of the accuracy in determining the corresponding object from images of the object, such as a person or a vehicle, included in the images captured by the camera 23, and stores them in the storage unit 110 as training data. Then, the images stored in the storage unit 110 are transmitted to the server 40, and are used to retrain the classification model.

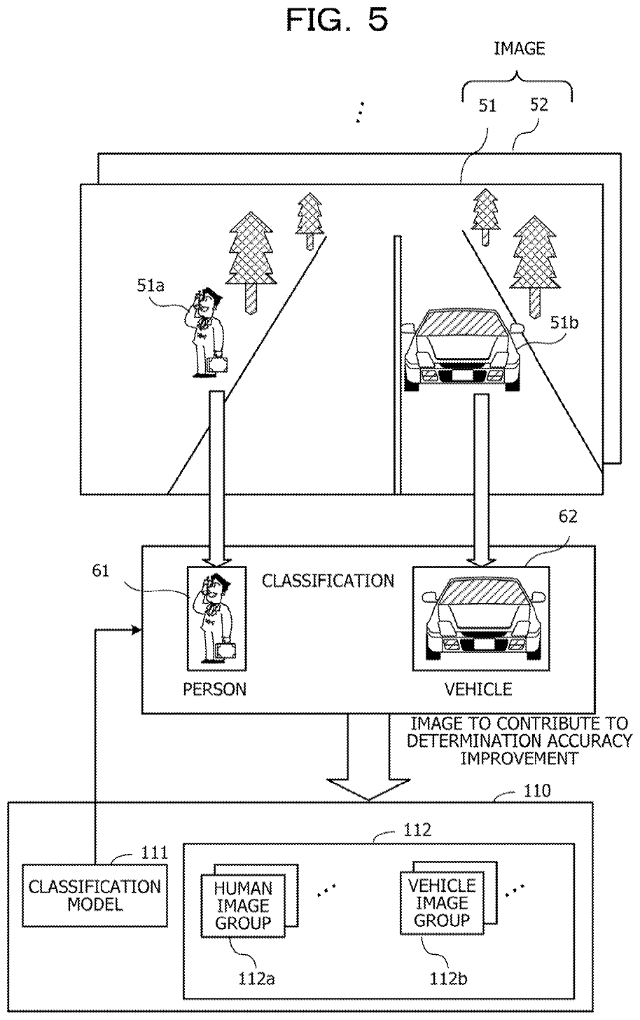

FIG. 5 is a diagram illustrating exemplary object image extraction from a captured image. The image acquisition unit 120 obtains a plurality of images 51, 52, and the like captured by the camera 23 in a time series manner. In the example of FIG. 5, a person 51a and a vehicle 51b are present in the image 51. The classification unit 130 that has received the image 51 from the image acquisition unit 120 cuts out, from the image 51, the area including the person 51a and the area including the vehicle 51b, for example, and sets them as object images 61 and 62.

Then, the classification unit 130 determines a type of the object that appears in the individual object images 61 and 62 using the classification model 111 stored in the storage unit 110. In the example of FIG. 5, it is determined that a person is present in the object image 61 and that a vehicle is present in the object image 62.

The periodicity detection unit 140 and the image comparison unit 150 determine whether or not the object images 61 and 62 whose types have been determined by the classification model 111 satisfy conditions of images that contribute to determination accuracy improvement, and store them in the storage unit 110 as training data 112 only when the conditions are satisfied.

The training data 112 retained in the storage unit 110 includes a human image group 112a and a vehicle image group 112b. The human image group 112a is a plurality of object images classified as persons. The vehicle image group 112b is a plurality of object images classified as vehicles.

Here, it is assumed that the classification model 111 is a trained model with parameters that have already been sufficiently adjusted by machine learning. The training data to be used to generate the classification model 111 may be, for example, images available to the public or images prepared on the assumption of an environment where image classification is needed. For example, it is assumed that the classification model 111 has been trained to have the classification confidence level of equal to or higher than 90% for important types such as a person or a vehicle. However, even when the classification model 111 is trained to have the confidence level of equal to or higher than 90%, the confidence level of an object image whose type is difficult to predict may be lower than 90%.

In the case of determining a type of the object present in the object images 61 and 62 using the classification model 111, the classification unit 130 calculates a probability of being the type for each type. Then, the classification unit 130 determines the type with the highest probability as the type of the object present in the object images 61 and 62.

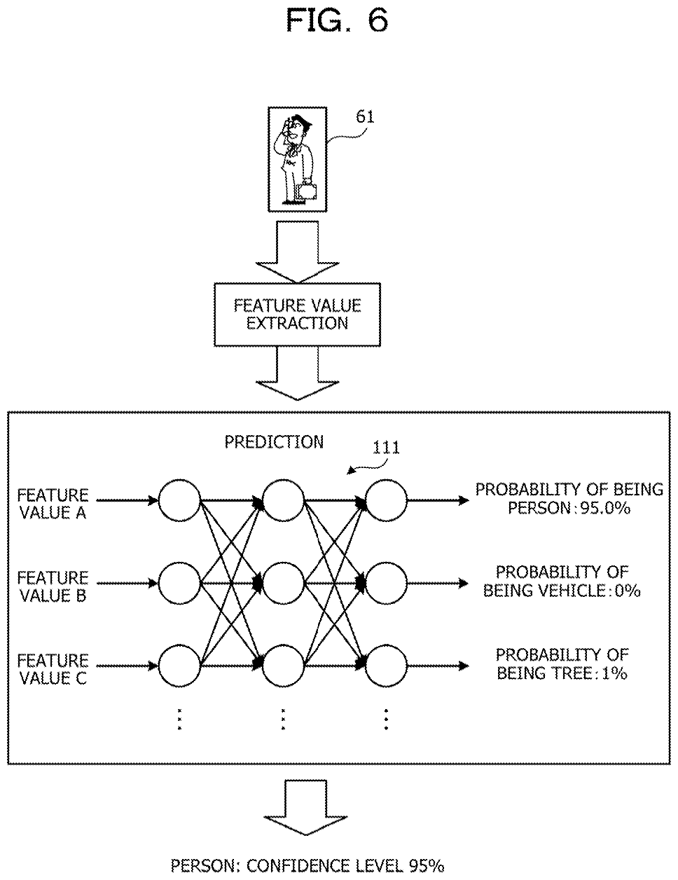

FIG. 6 is a diagram illustrating an exemplary process of determining a type of an object. The classification unit 130 analyzes the object image 61 and extracts a plurality of feature values. The classification unit 130 determines a type of the object present in the object image 61 on the basis of the classification model 111 using the extracted feature values as an input to the classification model 111. As a result of the determination, a probability of being the type is calculated for each type. In the example of FIG. 6, a probability that the type is a person is 95.0% which is the highest. The classification unit 130 takes the type “person” with the highest probability as a determination result. At this time, the value of the probability of being the type indicated in the determination result is called a confidence level. The classification unit 130 outputs the type “person” and the confidence level “95%” as the classification result of the object image 61.

Note that it is not easy to generate the training data 112 that further improves the determination accuracy of the classification model 111 that has already been classification model with equal to or higher than a certain level of accuracy. For example, when the types of the randomly obtained object images 61 and 62 are determined using the classification model 111, there is a polarized state in which the probability of being each type indicates near 0% or near 90%. Meanwhile, object images useful to retrain the classification model 111 do not have a high probability of being any type, and are images difficult to identify one type with certainty even using the classification model 111. By obtaining such images as training data and causing the server 40 to perform retraining using the training data, it becomes possible to correct the parameters of the classification model 111 in such a manner that object images that have been difficult to classify may also be correctly classified.

Here, it is also conceivable to use a method of saving a large number of object images and comparing them to select images that contribute to the determination accuracy improvement of the classification model 111. However, when such a method is adopted, a large number of images such as candidate images for training data that may not be used and training data that has already been used for training are retained for the image selection, resulting in inefficient processing.

In view of the above, in a case where the confidence level calculated at the time of type determination increases and decreases with periodicity, the edge device 100 determines that the object image at that time is an image difficult to determine with the current classification model 111, and that the object image contributes to the determination accuracy improvement of the classification model 111.

For example, the edge device 100 measures the periodicity of the classification confidence level per unit time so that how the confidence level changes according to changes in the input image may be detected. For example, in a case where the confidence level is equal to or higher than N % (N is a positive real number) while image classification is repeated periodically, the edge device 100 determines that there is periodicity when it becomes lower than N % according to movement of the object present in the image, and then becomes equal to or higher than N % again, and that phenomenon continues M times (M is a natural number). When the edge device 100 determines that there is periodicity, it cuts out the object image from the entire captured video to temporarily save it in the memory 102. Note that N is an example of the predetermined threshold value for the confidence level in the first embodiment. M is an example of the upper limit (predetermined number of times) of the number of repetitions when the predetermined threshold value is exceeded and when it is not exceeded in the first embodiment.

The user sets a classification correct answer rate by the trained classification model 111 that has first been created as an initial value of N indicating the threshold value for the periodic classification confidence level. The classification correct answer rate is a rate at which a result of image classification matches the original type (ground truth label) of the image. For example, the user assigns ground truth labels to the images collected by the server 40. As a result, training data is generated that includes pairs of images collected as the training data and the ground truth labels.

The server 40 retrains the classification model 111 using the generated training data. Then, the server 40 calculates the classification correct answer rate by the classification model 111 obtained by the retraining. The server 40 transmits the calculated correct answer rate to the edge device 100 as a new value of N. The edge device 100 updates N to the received value. Such a process is repeatedly executed.

For example, it is assumed that the classification correct answer rate of the trained classification model 111 that has first been created is approximately 90%. There is a modified national institute of standards and technology (MNIST) database as data that may be used for machine learning using images. When a convolutional neural network model is trained using a dataset of the MNIST database, the classification correct answer rate reaches 98%. Accordingly, the target classification correct answer rate is set in the upper half of the 90% range for the classification model 111 as well. In a case where the classification model 111 with the classification correct answer rate in the upper half of the 90% range is obtained, it may be expected that classification results are obtained with the confidence level in the upper half of the 90% range for many images in the classification using that classification model 111. In view of the above, in the edge device 100, the initial value of N for periodicity determination of the classification confidence level is set to 90%. Then, the value of N is repeatedly updated until it reaches the upper half of the 90% range as the classification model 111 is retrained.

The upper limit value M of the cycle count is set according to a situation where, for example, the classification confidence level changes visually within one second. When it is failed to detect periodicity within a predetermined period, the edge device 100 may decrease the value of M.

For example, a case where moving images with a frame rate of 30 fps are input to the edge device 100 will be assumed. At this time, when an inference execution frequency is set to ⅓ (once every 3 frames), the edge device 100 performs inference 10 times per second. In the edge device 100, the initial value of M, which is the upper limit value of the cycle count, is set to 5 times, for example, in anticipation of periodicity around the classification confidence level N %. The edge device 100 decrements the cycle count upper limit M by 1 when it fails to confirm periodicity after a certain period of time has elapsed. For example, the edge device 100 may change the inference execution frequency in a case where it fails to confirm periodicity even when M becomes 1.

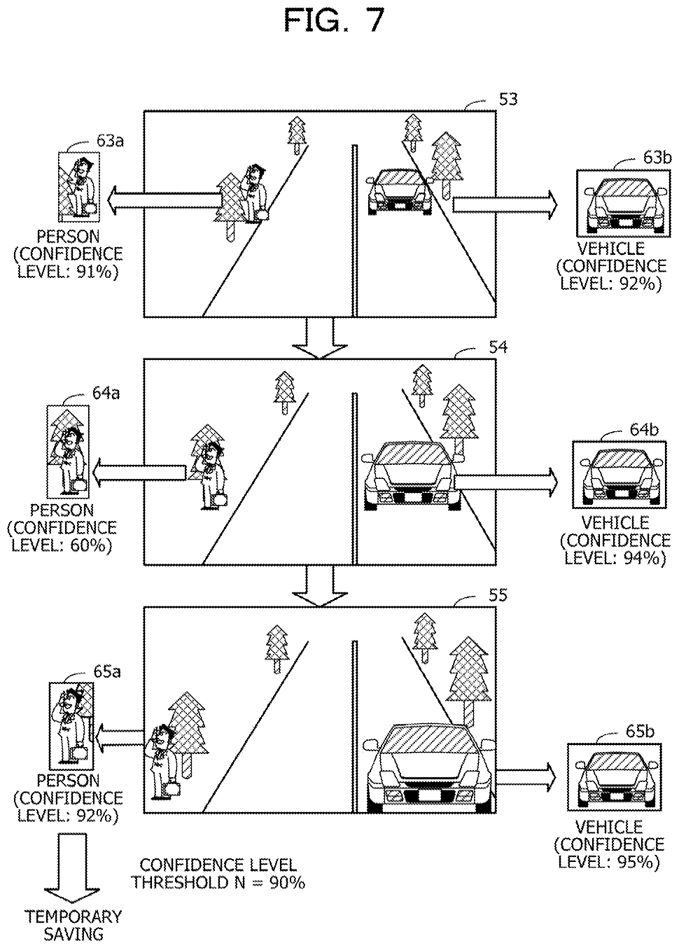

FIG. 7 is a diagram illustrating exemplary temporary saving of an object image. FIG. 7 illustrates images 53 to 55 captured by the camera 23 while the vehicle 31 drives forward. A person and a vehicle are present in the images 53 to 55.

A confidence level that a person is present in an object image 63a in the image 53 including a person, which is obtained by the classification unit 130, is 91%. A confidence level that a vehicle is present in an object image 63b in the image 53 including a vehicle, which is obtained by the classification unit 130, is 92%.

A confidence level that a person is present in an object image 64a in the image 54 including a person, which is obtained by the classification unit 130, is 60%. A confidence level that a vehicle is present in an object image 64b in the image 54 including a vehicle, which is obtained by the classification unit 130, is 94%.

A confidence level that a person is present in an object image 65a in the image 55 including a person, which is obtained by the classification unit 130, is 92%. A confidence level that a vehicle is present in an object image 65b in the image 55 including a vehicle, which is obtained by the classification unit 130, is 95%.

With regard to the object images 63b, 64b, and 65b in which a vehicle is present, the vehicle becomes larger and clearer as the shooting time becomes later, and the confidence level increases as time advances. In this manner, when an object simply approaches and the background does not largely differ, the confidence level does not have periodicity and has a certain tendency such as rising or falling. In the case of the object images 63b, 64b, and 65b, they may already be correctly classified by the classification model 111, and using the object images 63b, 64b, and 65b for retraining of the classification model 111 does not contribute to improvement of the classification accuracy.

On the other hand, with regard to the object images 63a, 64a, and 65a in which a person is present, a tree is included in the background, and a positional relationship between the person and the tree in the background changes as the person moves. Then, when the person and the tree overlaps with each other as in the object image 64a, the confidence level decreases. As a result, with regard to the object images 63a, 64a, and 65a, the confidence level repeats up and down along with the progress of the shooting time. At this time, N, which is a threshold value of the confidence level, is assumed to be 90%. Then, the confidence level of the object image 63a is equal to or higher than the threshold value, the confidence level of the object image 64a is lower than the threshold value, and the confidence level of the object image 65a is equal to or higher than the threshold value. For example, the confidence level periodically changes up and down across the threshold value.

The example of the object images 63a, 64a, and 65a indicates that even a slight deviation in the positional relationship between the person and the tree largely changes the confidence level in the type determination using the classification model 111. In this case, the classification performance of the classification model 111 may improve when the classification model 111 is retrained using the object images 63a, 64a, and 65a. For example, it becomes possible to correct the parameters of the classification model 111 in such a manner that even an image in which a person and a tree overlap with each other may be classified highly accurately. In view of the above, in the edge device 100, the periodicity detection unit 140 detects whether or not there is such periodicity of the confidence level, and temporarily saves at least one of the object images 63a, 64a, and 65a in the memory 102 when it succeeds in the detection.

In the edge device 100, no training data 112 is stored in the storage unit 110 in the initial state. Then, the edge device 100 formally saves the first object image to be temporarily saved as the training data 112 as it is. Thereafter, the edge device 100 determines whether or not there is periodicity in the confidence level of the object image again, and determines similarity between the object image and the object images in the training data 112 when the object image is temporarily saved. A method of digitizing an image and comparing a similarity level, which is represented by a perceptual hash, may be used to determine the similarity of the object image. When there is no similarity, the edge device 100 formally saves the image. The maximum number L (L is a natural number) to be formally saved is determined in advance according to the performance of the edge device 100.

For example, L is determined according to the size of the storage capacity of the edge device 100 within a range equal to or lower than the maximum value, which is the number of images used for retraining. A commonly used dataset of MNIST or Canadian Institute For Advanced Research (CIFAR)-10 contains 10,000 evaluation images in 10 categories. From this, it is considered appropriate that the number of images to be used for one retraining of the classification model 111 is 1,000 per classification. Accordingly, when the storage capacity of the edge device 100 that may be used to save images is sufficiently large, the maximum number of storage L is set to 1,000, for example. When the storage capacity of the edge device 100 that may be used to save images is small, the maximum number of saving L is set to 10, for example.

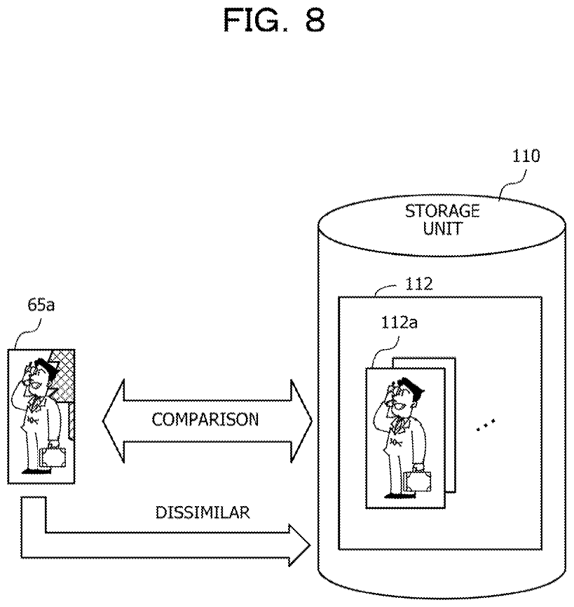

FIG. 8 is a diagram illustrating exemplary similarity level comparison of object images. For example, when the object image 65a in which a person is determined to be present is temporarily saved, the image comparison unit 150 compares the object image 65a with each of the object images included in the human image group 112a stored in the storage unit 110 as the training data 112. For example, when the temporarily saved object image 65a is similar to all the object images included in the human image group 112a, the image comparison unit 150 discards the temporarily saved object image 65a. Furthermore, when the temporarily saved object image 65a is dissimilar to at least one of the object images included in the human image group 112a, for example, the image comparison unit 150 stores the temporarily saved object image 65a in the storage unit 110 as the training data 112.

Note that whether or not there is periodicity in the confidence level of the object image is determined for each type (person, vehicle, etc.) of the object image. Furthermore, the number of saved object images is also managed for each type of the object image. The presence/absence of the periodicity and the number of saved objects for each object type are managed using a periodicity management table 141, for example.

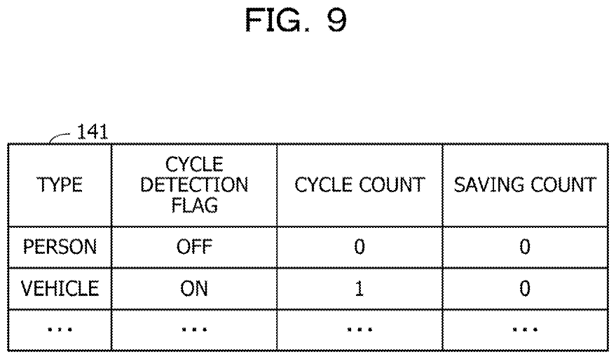

FIG. 9 is a diagram illustrating an example of the periodicity management table. The periodicity management table 141 is retained in an area within the memory 102 managed by the periodicity detection unit 140. In the periodicity management table 141, a cycle detection flag, a cycle count, and a saving count are set in association with a type of an object image. The cycle detection flag is a flag value indicating whether or not the confidence level in the previous classification process is equal to or higher than N. The cycle detection flag is set to “on” when the confidence level is equal to or higher than N, and the cycle detection flag is set to “off” when the confidence level is lower than N. The cycle count is information related to a duration of periodicity. Each time the value of the periodicity flag is switched, the value of the cycle count is incremented. The saving count is the number of saved object images. Each time an object image of the corresponding type is formally saved, the value of the saving count is incremented.

Note that the periodicity management table 141 is also referred to by the image comparison unit 150. Furthermore, the value of the saving count in the periodicity management table 141 is updated by the image comparison unit 150.

Next, a procedure of a training data generation process will be described in detail.

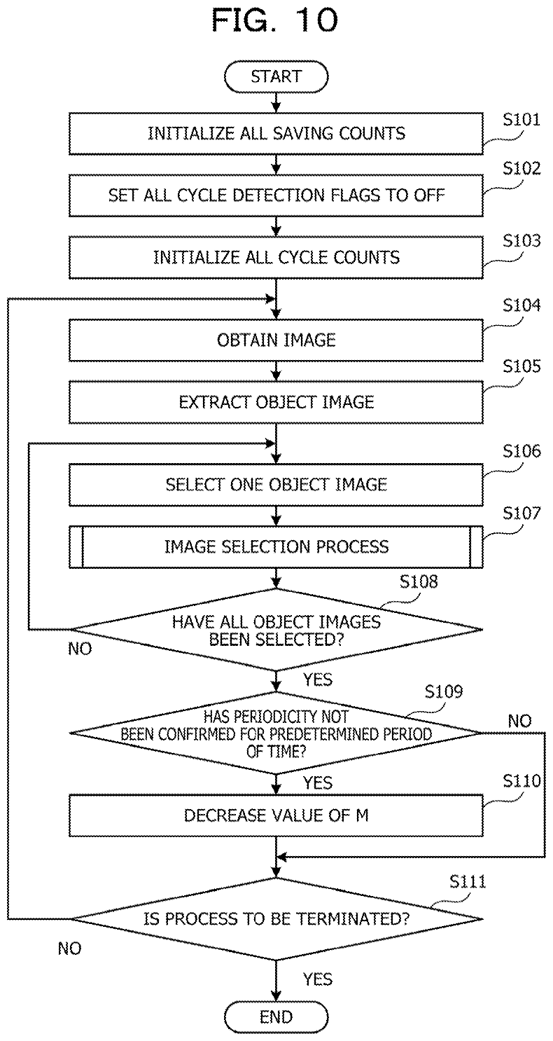

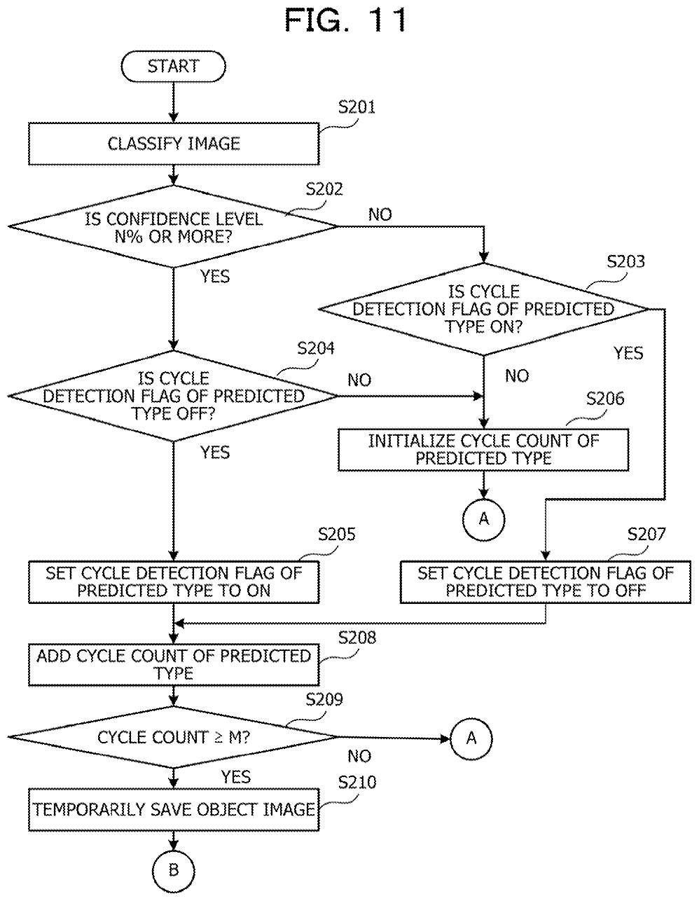

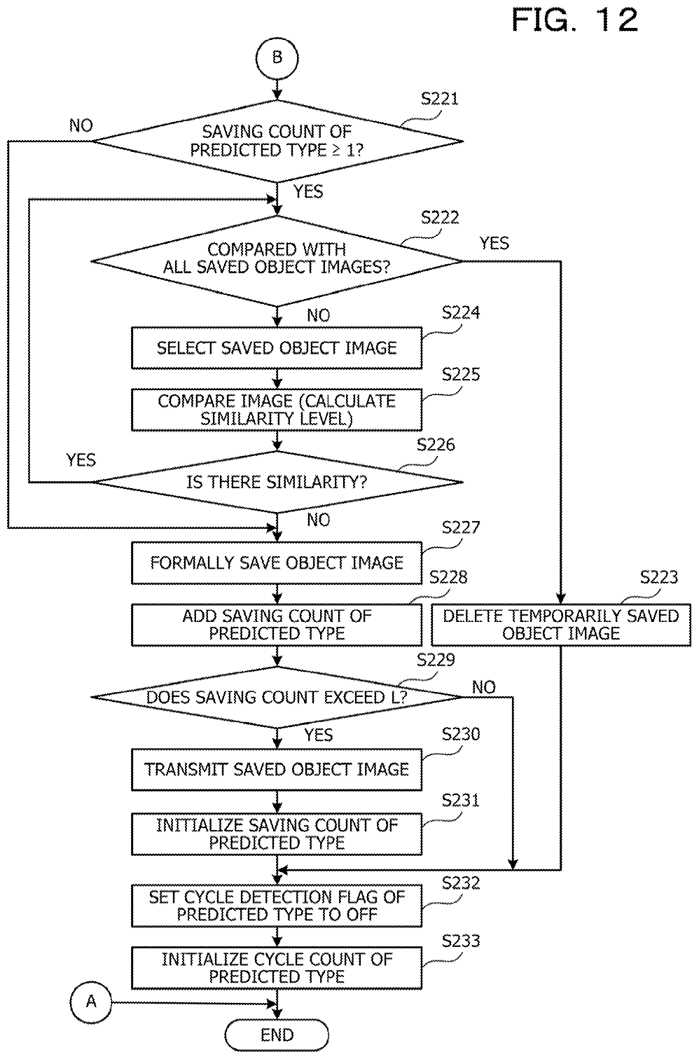

FIG. 10 is a flowchart illustrating an example of the procedure of the training data generation process. Hereinafter, a process illustrated in FIG. 10 will be described in accordance with step numbers.

[Step S101] The periodicity detection unit 140 initializes the saving counts for all types in the periodicity management table 141 to “0”.

[Step S102] The periodicity detection unit 140 sets the values of the cycle detection flags for all the types in the periodicity management table 141 to “off”.

[Step S103] The periodicity detection unit 140 initializes the cycle counts for all the types in the periodicity management table 141 to “0”.

[Step S104] The image acquisition unit 120 obtains an image from a camera. Image acquisition is repeatedly carried out at regular time intervals. At a time of the second and subsequent image acquisition, the image acquisition unit 120 obtains images after confirming that a predetermined period of time (e.g., several seconds) has elapsed since the previous image acquisition. The image acquisition unit 120 transmits the obtained images to the classification unit 130.

[Step S105] The classification unit 130 extracts, as an object image, areas in which an object of a type such as a person or a vehicle may be present in the obtained images.

[Step S106] The classification unit 130 selects one unselected object image from the extracted object images.

[Step S107] The classification unit 130, the periodicity detection unit 140, the image comparison unit 150, and the training data transmission unit 160 cooperate to perform an image selection process. Details of the image selection process will be described later (see FIGS. 11 and 12).

[Step S108] The classification unit 130 determines whether or not all the object images extracted from the obtained images have been selected. If all the object images have been selected, the classification unit 130 advances the process to step S109. Furthermore, if there is an unselected object image, the classification unit 130 advances the process to step S106.

[Step S109] The periodicity detection unit 140 determines whether or not the periodicity in the confidence level has not been confirmed for a predetermined period of time. For example, if the cycle count is equal to or more than M and the number of images with the temporarily saved object images is “0” during the most recent predetermined period of time, the periodicity detection unit 140 determines that the periodicity in the confidence level has not been confirmed for the predetermined period of time. If the periodicity in the confidence level has not been confirmed, the periodicity detection unit 140 advances the process to step S110. Furthermore, if the periodicity in the confidence level has been confirmed, the periodicity detection unit 140 advances the process to step S111.

[Step S110] The periodicity detection unit 140 decreases the value of M representing the upper limit of the cycle count. For example, when the value of M is equal to or higher than 2, the periodicity detection unit 140 decreases the value of M by 1.

[Step S111] If an instruction for terminating the process is input, the image acquisition unit 120 terminates the training data generation process. Furthermore, if the instruction for terminating the process is not input, the image acquisition unit 120 advances the process to step S104.

In this manner, an object image is extracted from the periodically obtained images, and if the extracted object image is an image that contributes to the improvement of the classification model performance, the object image is added to the training data in the image selection process (step S107).

Next, the image selection process will be described in detail with reference to FIGS. 11 and 12.

FIG. 11 is a first half of a flowchart illustrating an exemplary procedure of the image selection process. Hereinafter, a process illustrated in FIG. 11 will be described in accordance with step numbers.

[Step S201] The classification unit 130 classifies types of objects present in the selected object image using the classification model 111. For example, the classification unit 130 calculates a feature value of the object image, performs an operation according to parameters set in the classification model 111 using the obtained feature value as an input to the classification model 111, and calculates, for each type, a probability that the object is the type. The classification unit 130 predicts that the type with the highest probability obtained is the type of the object present in the object image. The confidence level indicates the probability that the type of the object is the predicted type. The classification unit 130 transmits the predicted type and the confidence level to the periodicity detection unit 140.

[Step S202] The periodicity detection unit 140 determines whether or not the obtained confidence level is equal to or higher than the confidence level of N %. The periodicity detection unit 140 advances the process to step S204 if the confidence level is equal to or higher than N %. Furthermore, if the confidence level is lower than N %, the periodicity detection unit 140 advances the process to step S203.

[Step S203] The periodicity detection unit 140 determines whether or not the cycle detection flag of the predicted type is “on”. If the cycle detection flag is “on” in the case where the confidence level is lower than N %, the periodicity detection unit 140 advances the process to step S207. Furthermore, if the cycle detection flag is “off” in the case where the confidence level is lower than N %, the periodicity detection unit 140 advances the process to step S206.

[Step S204] The periodicity detection unit 140 determines whether or not the cycle detection flag of the predicted type is “off”. If the cycle detection flag is “off” in the case where the confidence level is equal to or higher than N %, the periodicity detection unit 140 advances the process to step S205. Furthermore, if the cycle detection flag is “on” in the case where the confidence level is equal to or higher than N %, the periodicity detection unit 140 advances the process to step S206.

[Step S205] The periodicity detection unit 140 sets the value of the cycle detection flag of the predicted type to “on”. Thereafter, the periodicity detection unit 140 advances the process to step S208.

[Step S206] The periodicity detection unit 140 initializes the cycle count of the predicted type to “0”. For example, the cycle count is reset when the confidence levels of consecutive object images are both equal to or higher than N % or both lower than N %. Thereafter, the periodicity detection unit 140 terminates the image selection process.

[Step S207] The periodicity detection unit 140 sets the value of the cycle detection flag of the predicted type to “off”. Thereafter, the periodicity detection unit 140 advances the process to step S208.

[Step S208] The periodicity detection unit 140 adds “1” to the cycle count of the predicted type. For example, the cycle count is incremented each time the processing of step S205 and the processing of S207 are alternately repeated.

[Step S209] The periodicity detection unit 140 determines whether or not the value of the cycle count of the predicted type is equal to or higher than M. If the value of the cycle count is equal to or higher than M, the periodicity detection unit 140 advances the process to step S210. Furthermore, if the value of the cycle count is lower than M, the periodicity detection unit 140 terminates the image selection process.

[Step S210] The periodicity detection unit 140 temporarily saves the selected object image in the memory 102. Thereafter, the periodicity detection unit 140 advances the process to step S221 (see FIG. 12).

FIG. 12 is a latter half of the flowchart illustrating the exemplary procedure of the image selection process. Hereinafter, a process illustrated in FIG. 12 will be described in accordance with step numbers.

[Step S221] The image comparison unit 150 determines whether or not the saving count of the predicted type is equal to or higher than “1”. If the first temporary saving of the predicted type is performed this time and the saving count is still “0”, the image comparison unit 150 advances the process to step S227. Furthermore, if at least one object image has already been formally saved and the saving count is equal to or higher than “1”, the image comparison unit 150 advances the process to step S222.

[Step S222] The image comparison unit 150 determines whether or not the temporarily saved object image has been compared with all the saved object images. If the comparison with all the object images has been complete, the image comparison unit 150 advances the process to step S223.

Furthermore, if there is an object image that has not been compared, the image comparison unit 150 advances the process to step S224.

[Step S223] The image comparison unit 150 deletes the temporarily saved object image from the memory 102. Thereafter, the image comparison unit 150 advances the process to step S232.

[Step S224] The image comparison unit 150 selects one unselected object image from the saved object images of the predicted type.

[Step S225] The image comparison unit 150 compares the temporarily saved object image with the selected saved object image, and calculates a similarity level. For example, the image comparison unit 150 calculates a perceptual hash value for both of the temporarily saved object image and the selected saved object image. The calculated value is a bit string with a predetermined number of bits. The image comparison unit 150 calculates a Hamming distance between the perceptual hash values of the two individual object images. In this case, the similarity level is higher as the Hamming distance value is smaller.

[Step S226] The image comparison unit 150 determines whether or not there is similarity on the basis of whether or not the similarity level is equal to or higher than a predetermined similarity threshold value. For example, if the Hamming distance between the perceptual hash values is equal to or greater than a predetermined value (e.g., “10”), the image comparison unit 150 determines that the two object images are dissimilar to each other. If there is similarity, the image comparison unit 150 advances the process to step S222. Furthermore, if there is no similarity, the image comparison unit 150 advances the process to step S227.

[Step S227] The image comparison unit 150 formally saves the object image in the storage unit 110 as the training data 112.

[Step S228] The image comparison unit 150 adds 1 to the saving count of the predicted type.

[Step S229] The image comparison unit 150 determines whether or not the value of the saving count of the predicted type exceeds the maximum number of saving L. If L is exceeded, the image comparison unit 150 advances the process to step S230. Furthermore, if L is not exceeded, the image comparison unit 150 advances the process to step S232.

[Step S230] The training data transmission unit 160 transmits the saved object image of the predicted type to the server 40.

[Step S231] The training data transmission unit 160 initializes the saving count of the predicted type to “0”.

[Step S232] The periodicity detection unit 140 sets the cycle detection flag of the predicted type to “off”.

[Step S233] The periodicity detection unit 140 initializes the cycle count of the predicted type to “0”.

In this manner, the edge device 100 carries out the image selection on the basis of the confidence level and the candidate images for the training data. Most of the edge devices 100 are required to have less storage capacity and less data communication. Accordingly, in collecting training data using the edge device 100, the edge device 100 carries out the image selection by itself and is enabled to transmit only images that contribute to the accuracy improvement of the classification model to the server, whereby the communication volume of the entire system may be significantly reduced, which improves the processing efficiency.

### OTHER EMBODIMENTS

The inference by the edge device 100 is characterized by resource-saving, power-saving, and space-saving features of the edge device alone, and may be effectively used not only when used in a vehicle, but also at sites where real-time performance is required, such as construction sites. With the edge device 100 described in the second embodiment used at a time of collecting training data from images captured at such various sites, it becomes possible to collect the training data efficiently.

Furthermore, when the communication band from the camera 23 to the server 40 has a margin and the communication load does not have to be considered, the training data generation process illustrated in FIGS. 10 to 12 may be carried out by the server 40. In that case as well, the server 40 does not need to save and manage a large number of images, and the processing efficiency may improve.

While the embodiments have been exemplified as described above, the configuration of each unit described in the embodiments may be replaced with another configuration having a similar function. Furthermore, any other components and steps may be added. Moreover, any two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an image processing program for causing a computer to execute a process comprising:
obtaining a plurality of images consecutively captured in a time series manner;
calculating a probability that a type of an object present in each of the plurality of images is one type using a trained classification model;
determining whether or not the probability that the type of the object is the one type periodically changes in consecutive images among the plurality of images; and
in a case of determining that the probability periodically changes, saving one image within a period in which the probability that the type of the object is the one type periodically changes as training data.

2. The non-transitory computer-readable recording medium according to claim 1, wherein
the determining whether or not the probability periodically changes determines whether or not a case where the probability that the type of the object is the one type exceeds a predetermined threshold value and a case where the probability does not exceed the predetermined threshold value are alternately repeated equal to or more than a predetermined number of times, and determines that the probability periodically changes when the case where the probability exceeds the predetermined threshold value and the case where the probability does not exceed the predetermined threshold value are alternately repeated equal to or more than the predetermined number of times.

3. The non-transitory computer-readable recording medium according to claim 2, wherein
the predetermined threshold value includes a value according to determination accuracy of the one type using the classification model.

4. The non-transitory computer-readable recording medium according to claim 2, the recording medium storing the program for causing the computer to execute the image processing process further comprising:
decreasing a value of the predetermined number of times when a determination that the probability periodically changes is not made for a predetermined period of time.

5. The non-transitory computer-readable recording medium according to claim 1, wherein
the saving the one image as the training data calculates a similarity level between the one image and each of images saved as the training data, and saves the one image as the training data when the similarity level satisfies a predetermined condition.

6. The non-transitory computer-readable recording medium according to claim 5, wherein
the predetermined condition for the similarity level includes that the similarity level between the one image and at least one of the images saved as the training data is lower than a predetermined similarity threshold value.

7. A image processing method comprising:
obtaining a plurality of images consecutively captured in a time series manner;
calculating a probability that a type of an object present in each of the plurality of images is one type using a trained classification model;
determining whether or not the probability that the type of the object is the one type periodically changes in consecutive images among the plurality of images; and
in a case of determining that the probability periodically changes, saving one image within a period in which the probability that the type of the object is the one type periodically changes as training data.

8. An information processing apparatus comprising:
a memory; and
a processor coupled to the memory and configured to:
obtain a plurality of images consecutively captured in a time series manner;
calculate a probability that a type of an object present in each of the plurality of images is one type using a trained classification model;
determine whether or not the probability that the type of the object is the one type periodically changes in consecutive images among the plurality of images; and
in a case of determining that the probability periodically changes, save one image within a period in which the probability that the type of the object is the one type periodically changes as training data.
